(19) United States
(12) Patent Application Publication
(10) Pub. No.: US 2019/0189063 A1
(43) Pub. Date: Jun. 20, 2019

(54) LIGHT EMISSION CONTROL APPARATUS AND LIGHT EMISSION CONTROL METHOD

(71) Applicant: CANON KABUSHIKI KAISHA, Tokyo (JP)

(72) Inventors: Tetsu Kitani, Kawasaki-shi (JP); Mitsuru Tada, Machida-shi (JP)

(21) Appl. No.: 16/203,805

(22) Filed: Nov. 29, 2018

(30) Foreign Application Priority Data
Dec. 14, 2017 (JP) 2017-239626

(51) Int. Cl. G09G 3/34; G02F 1/1335

(52) U.S. Cl. CPC G09G 3/3426; G02F 1/133603; G09G 2330/021; G09G 2310/08; G09G 2320/0626; G02F 1/133611

(57) ABSTRACT

A light emission control apparatus includes: a transmittance determining unit that determines, based on image data, a temporal change in transmittance of a display unit of the display apparatus in a frame period; and a pulse determining unit that determines, based on a determination result by the transmittance determining unit, for each of partial periods in the frame period, a pulse width, a pulse amplitude, and a pulse position of a pulse supplied to a light-emitting unit of the display apparatus, wherein the pulse determining unit determines a pulse position for each partial period so that the pulse is set in a period where the transmittance in the partial period is relatively high, and determines, for a stable period, a pulse width and a pulse amplitude that are different from those of an unstable period.

### BACKGROUND OF THE INVENTION

### Field of the Invention

The present invention relates to a light emission control apparatus and a light emission control method.

### Description of the Related Art

In recent years, the demand levels of users for liquid crystal display apparatuses are increasing. In particular, the demand levels for higher brightness in displays, lower power consumption of apparatuses and the like are elevated. When a liquid crystal apparatus is used outdoors, for example, the liquid crystal display apparatus may be battery driven. In the case of driving a liquid crystal display apparatus by battery, it is difficult to implement both higher brightness and lower power consumption in the apparatus.

In the case of the liquid crystal display apparatus, of which the liquid crystal panel is not self-emitting, a backlight apparatus, of which the light source is a light-emitting diode (LED) or the like, is required. To control the light quantity of emission of the backlight apparatus, the pulse amplitude modulation (PAM) control, the pulse width modulation (PWM) control, a combination of the PAM control and the PWM control and the like are used.

The PAM control is a control method to control the pulse amplitude of the pulse supplied to the backlight apparatus. By controlling the current value (DC value) of the current supplied to the backlight apparatus, the pulse amplitude can be controlled. The PWM control is a control method to control the pulse width of the pulse supplied to the backlight apparatus. By controlling the supply time of the current that is supplied to the backlight apparatus, the pulse width can be controlled. In a liquid crystal display apparatus, a pulse corresponding to a frame period, where one frame of the image data is displayed, is set for the frame period. In the PWM control, by controlling the pulse width, the duty ratio of the backlight apparatus (ratio of the length (time) of the ON period of the backlight apparatus in a frame period and the length of the OFF period of the backlight apparatus in this frame period) is controlled.

When one pulse is set in a long frame period, the user may recognize flickering caused by the blinking backlight apparatus. Therefore a pulse is normally set to a frequency that is higher than the frame frequency of the image data. For example, if the frame frequency of the image data is 60 Hz, a plurality of sub-frame periods (partial periods) are set in a frame period, and a pulse is set for each of the plurality of sub-frame periods respectively.

It is known that a certain amount of time is required from the start of applying voltage (voltage based on the image data) to the liquid crystal panel to the transmittance of the liquid crystal panel reaching a desired transmittance (transmittance based on the image data). Further, in order to implement a desired display brightness, the backlight apparatus may be turned ON even during a period where a temporal change is generated in the transmittance of the liquid crystal panel. In this case, some emission waste is generated in the backlight apparatus for such a reason as the light emitted from the backlight apparatus has not been fully transmitted through the liquid crystal panel. This emission loss is particularly large and diminishes the power efficiency if the pulse width, the pulse amplitude and the pulse position (relative position of the pulse with respect to the sub-frame period) are the same among a plurality of sub-frame periods. In other words, power consumption of the apparatus cannot be sufficiently reduced even if a desired display brightness is implemented. The display brightness corresponds to the total quantity of light emitted from the liquid crystal panel during the frame period.

Japanese Patent Application Publication No. 2009-158275 discloses a technique to turn ON the backlight apparatus more in the latter half during the frame period. According to the technique in Japanese Patent Application Publication No. 2009-158275, the backlight apparatus is turned ON during a period in which the transmittance is high in the case when the transmittance of the liquid crystal panel gradually increases in a frame period, hence power efficiency is improved.

### SUMMARY OF THE INVENTION

However, image data varies, hence the temporal changes in the transmittance of the liquid crystal panel also varies. Therefore in some cases, the power efficiency may not improve even if the technique according to Japanese Patent Application Publication No. 2009-158275 is used. When the transmittance of the liquid crystal panel gradually decreases during a frame period, the backlight apparatus is turned ON in a period in which the transmittance is low, so in this case the power efficiency does not improve.

With the foregoing in view, the present invention provides a technique which allows reducing the power consumption of an apparatus at high precision, while implementing a desired display brightness.

The present invention in its first aspect provides a light emission control apparatus configured to control light emission of a light-emitting unit of a display apparatus which includes the light-emitting unit and a display unit configured to display an image on a display surface by transmitting light emitted from the light-emitting unit based on image data, the light emission control apparatus comprising at least one processor that operates as:

a transmittance determining unit configured to determine, based on the image data, a temporal change in transmittance of the display unit in a frame period in which one frame of the image data is displayed; and

a pulse determining unit configured to determine, based on a determination result by the transmittance determining unit, for each of a plurality of partial periods in the frame period, a pulse width which is a width of a pulse supplied to the light-emitting unit, a pulse amplitude which is an amplitude of the pulse, and a pulse position which is a relative position of the pulse with respect to the partial period, so that a target quantity of light is emitted from the display t in the frame period, wherein

the pulse determining unit

determines a pulse position for each partial period so that the pulse is set in a period where the transmittance of the display unit in the partial period is relatively high, and

determines, for a stable period that is a partial period in which the transmittance of the display unit is approximately constant, a pulse width and a pulse amplitude that are different from a pulse width and a pulse amplitude of an unstable period that is a partial period in which the transmittance of the display unit is approximately not constant.

The present invention in its second aspect provides a light emission control method for controlling light emission of a light-emitting unit of a display apparatus which includes the light-emitting unit and a display unit configured to display an image on a display surface by transmitting light emitted from the light-emitting unit based on image data, the light emission control method comprising:

a transmittance determining step of determining, based on the image data, a temporal change in transmittance of the display unit in a frame period in which one frame of the image data is displayed; and

a pulse determining step of determining, based on a determination result in the transmittance determining step, for each of a plurality of partial periods in the frame period, a pulse width which is a width of a pulse supplied to the light-emitting unit, a pulse amplitude which is an amplitude of the pulse, and a pulse position which is a relative position of the pulse with respect to the partial period, so that a target quantity of light is emitted from the display unit in the frame period, wherein

in the pulse determining step,

a pulse position is determined for each partial period so that the pulse is set in a period where the transmittance of the display unit in the partial period is relatively high, and

for a stable period that is a partial period in which the transmittance of the display unit is approximately constant, a pulse width and a pulse amplitude that are different from a pulse width and a pulse amplitude of an unstable period are determined, the unstable period being a partial period in which the transmittance of the display unit is approximately not constant.

The present invention in its third aspect provides a non-transitory computer readable medium that stores a program, wherein

the program causes a computer to execute a light emission control method for controlling light emission of a light-emitting unit of a display apparatus which includes the light-emitting unit and a display unit configured to display an image on a display surface by transmitting light emitted from the light-emitting unit based on image data,

the light emission control method includes:

a transmittance determining step of determining, based on the image data, a temporal change in transmittance of the display unit in a frame period in which one frame of the image data is displayed; and

a pulse determining step of determining, based on a determination result in the transmittance determining step, for each of a plurality of partial periods in the frame period, a pulse width which is a width of a pulse supplied to the light-emitting unit, a pulse amplitude which is an amplitude of the pulse, and a pulse position which is a relative position of the pulse with respect to the partial period, so that a target quantity of light is emitted from the display unit in the frame period, and

in the pulse determining step,

a pulse position is determined for each partial period so that the pulse is set in a period where the transmittance of the display unit in the partial period is relatively high, and

for a stable period that is a partial period in which the transmittance of the display unit is approximately constant, a pulse width and a pulse amplitude that are different from a pulse width and a pulse amplitude of an unstable period are determined, the unstable period being a partial period in which the transmittance of the display unit is approximately not constant.

According to the present invention, the power consumption of an apparatus can be reduced at high precision while implementing a desired display brightness.

Further features of the present invention will become apparent from the following description of exemplary embodiments with reference to the attached drawings.

### BRIEF DESCRIPTION OF THE DRAWINGS

FIG. 1 is a block diagram depicting a configuration example of a liquid crystal display apparatus according to Example 1;

FIG. 2 is a diagram depicting a configuration example of a backlight apparatus according to Example 1;

FIG. 3 is a flow chart depicting an example of a processing flow of a backlight control apparatus according to Example 1;

FIG. 4 is a diagram depicting an example of a temporal change in the transmittance of a liquid crystal panel according to Example 1;

FIGS. 5A to 5C are diagrams depicting a concrete example of a pulse determining method according to Example 1;

FIGS. 6A to 6F are diagrams depicting a concrete example of the effect acquired in Example 1;

FIG. 7 is a flow chart depicting an example of a processing flow of a backlight control apparatus according to Example 2;

FIGS. 8A to 8F are diagrams depicting a concrete example of the effect acquired in Example 2; and

FIG. 9 is a flow chart depicting an example of a processing flow of a backlight control apparatus according to Example 3.

### DESCRIPTION OF THE EMBODIMENTS

### EXAMPLE 1

Example 1 of the present invention will be described. A light emission control apparatus according to Example 1 controls the emission of a light-emitting unit of a display apparatus constituted by this light-emitting unit, and a display unit which displays an image on a display surface by transmitting the light emitted from the light-emitting unit based on the image data. Here an example of disposing the light emission control apparatus in a liquid crystal display will be described. The light emission control apparatus may be an apparatus (e.g. personal computer) that is separate from the liquid crystal display apparatus. The display apparatus need not be a liquid crystal apparatus. For example, the display apparatus may have a micro-electro mechanical system (MEMS) shutter type display panel instead of the liquid crystal panel. The display apparatus may be a projector.

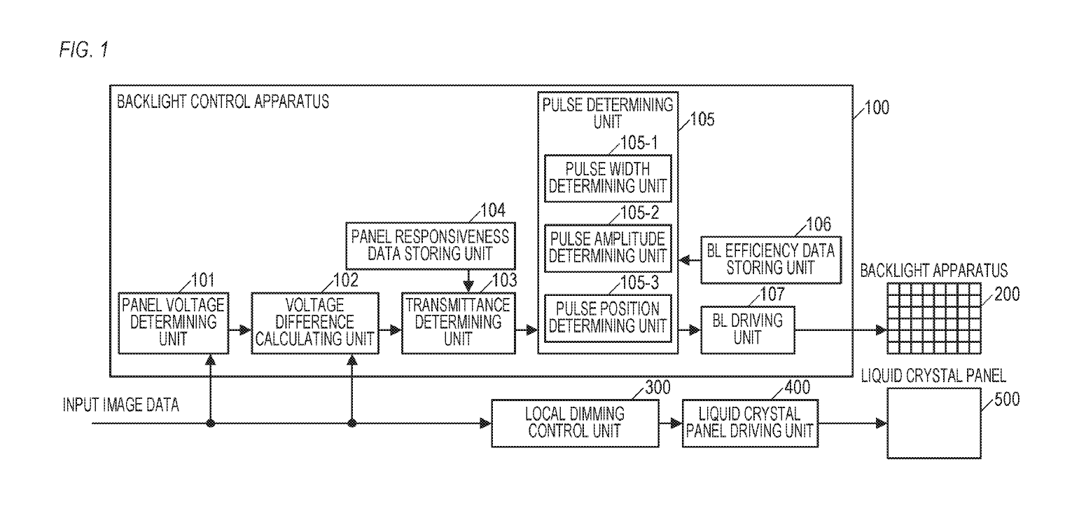

A configuration example of the liquid crystal display apparatus according to Example 1 will be described. FIG. 1 is a block diagram depicting a configuration example of the liquid crystal display apparatus according to Example 1. The liquid crystal display apparatus according to Example 1 includes a backlight control apparatus 100, a backlight apparatus 200, a local dimming control unit 300, a liquid crystal panel driving unit 400 and a liquid crystal panel 500.

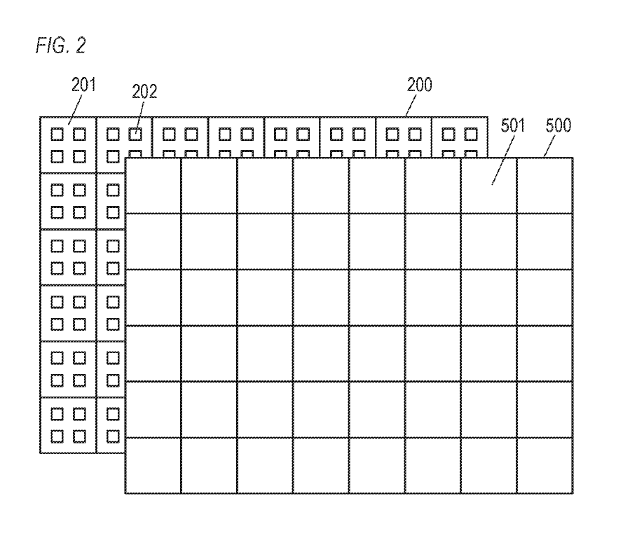

The backlight apparatus 200 is a light-emitting unit configured to irradiate light to the rear surface of the liquid crystal panel 500. FIG. 2 illustrates a configuration example of the backlight apparatus 200. The backlight apparatus 200 has a plurality of light source units 201 which correspond to a plurality of partial areas on the display surface respectively. The light emission of each light source unit 201 can be independently controlled. In FIG. 2, the plurality of partial areas are a plurality of divided areas 501 constituting the display surface. The plurality of divided areas 501 are arranged in a matrix, and the shape of each divided area 501 is rectangular. Each light source unit 201 has at least one light source (light-emitting element). The light source is a light-emitting diode (LED), an organic electro-luminescence (EL) element, a cold cathode tube or the like. In FIG. 2, each light source unit 201 has four LEDs 202.

The shape of a partial area, number of partial areas, arrangement of the partial areas, number of light source units, arrangement of light source units, number of light sources, arrangement of light sources and the like are not especially limited. For example, a plurality of partial areas may be arranged in a checkerboard pattern. The partial area need not be a divided area. For example, the partial area may be distant from other partial areas, or at least a part of a partial area may overlap with at least a part of the other partial areas. The correspondence of the partial area and the light source unit need not be a 1 to 1 correspondence. For example, at least two light source units may correspond to one partial area. A number of light source units may be one. In this case, the partial area corresponding to the light source may be the entire display surface or a part of the display surface.

The liquid crystal panel 500 is a display unit configured to display an image on the display surface by transmitting the light emitted from the backlight apparatus 200 based on the image data (image data input to the liquid crystal display apparatus; input image data).

The liquid crystal panel driving unit 400 is a driving circuit that controls the transmittance of the liquid crystal panel 500 based on the input image data. In concrete terms, the liquid crystal panel driving unit 400 controls the voltage applied to the liquid crystal panel 500 based on the input image data.

The local dimming control unit 300 determines the target light quantity based on the input image data. The target light quantity is a target quantity of light that is emitted from the liquid crystal panel 500 in a frame period where one frame of the input image data is displayed. In Example 1, the target light quantity is determined for each divided area 501 based on the portion of the input image data that is displayed on this divided area 501. For example, the frame period is determined by clock signals that are generated at a frequency corresponding to the frame frequency of the input image data. The local dimming control unit 300 may determine the target quantity of light that is emitted from the backlight apparatus 200 (light source unit 201) in the frame period.

The backlight control apparatus 100 is a light emission control apparatus configured to control the light emission of the backlight apparatus 200 based on the target light quantity determined by the local dimming control unit 300. In Example 1, for each light source unit 201, the light emission of the target light source unit 201 is controlled based on the target light quantity determined for the divided area 501 corresponding to this light source unit 201.

The backlight control apparatus 100 includes a panel voltage determining unit 101, a voltage difference calculating unit 102, a transmittance determining unit 103, a panel responsiveness data storing unit 104, a pulse determining unit 105, a BL efficiency data storing unit 106 and a BL driving unit 107.

The panel voltage determining unit 101 has a RAM (not illustrated) in which information on the correspondence between the gradation value of the input image data and the voltage applied to the liquid crystal panel 500 (liquid crystal element, which is a display element of the liquid crystal panel 500) is stored in advance. The panel voltage determining unit 101 determines the voltage to be applied to each liquid crystal element of the liquid crystal panel 500 based on the input image data. Then the panel voltage determining unit 101 records the determined voltage in the RAM of this panel voltage determining unit 101. The voltage is determined for each frame. The RAM of the panel voltage determining unit 101 holds voltage for two frames (a current frame, which is the current processing target, and a previous frame, which is the frame before the current frame) of the input image data.

The voltage difference calculating unit 102 calculates the difference (voltage difference) between a voltage that the panel voltage determining unit 101 determined for the current frame, and a voltage that the panel voltage determining unit 101 determined for the previous frame. The voltage difference calculating unit 102 calculates an average voltage difference for each divided area 501. In concrete terms, the panel voltage determining unit 101 or the voltage difference calculating unit 102 calculates, for each divided area 501, an average of a plurality of voltages corresponding to the plurality of liquid crystal elements in the target divided area 501 respectively (average element voltage). Then for each divided area 501, the voltage difference calculating unit 102 calculates the difference between the average element voltage of the current frame, and the average element voltage of the previous frame. The voltage difference calculating unit 102 may calculate the voltage difference for each liquid crystal element (element voltage difference), and may calculate, for each divided area 501, the average of a plurality of element voltage differences corresponding to a plurality of liquid crystal elements in the target divided area 501 respectively. Instead of the average value, a maximum value, a minimum value, a mode, a median or the like may be used.

In the panel responsiveness data storing unit 104, a panel responsiveness data is recorded in advance. The panel responsiveness data is data on the correspondence between: the voltage difference (difference of voltages applied to the liquid crystal panel 500) between two continuous frames and the temporal change in the transmittance of the liquid crystal panel 500 in the frame period of the later of these two frame.

The transmittance determining unit 103 determines the temporal change in the transmittance of the liquid crystal panel 500 in the current frame period (frame period of current frame) based on the input image data. In concrete terms, the transmittance determining unit 103 determines the temporal change for each divided area 501 based on the voltage difference that the voltage difference calculating unit 102 calculated for the target divided area 501, and the panel responsiveness data stored in the panel responsiveness data storing unit 104.

In this embodiment, a plurality of partial periods (sub-frame periods) are set in a frame period in advance. In concrete terms, a plurality of divided periods constituting a frame period are set in advance as the plurality of sub-frame periods. The transmittance determining unit 103 determines whether the current sub-frame period (current processing target sub-frame period; sub-frame period in the current frame period) is a stable period or an unstable period based on the above mentioned temporal change. The determination whether the sub-frame period is a stable period or unstable period is also performed for each divided area 501. The stable period is a period when the transmittance of the liquid crystal panel 500 is approximately constant, and the unstable period is a period when the transmittance of the liquid crystal panel 500 is approximately not constant (the meaning of “approximately” here includes “precisely”). The stable period can be regarded as a converged period when the transmittance of the liquid crystal panel 500 is converged, and the unstable period can be regarded as an unconverged period when the transmittance of the liquid crystal panel 500 has not yet converged. A number of sub-frame periods in a frame period is not especially limited. Further, the sub-frame period is not limited to the divided period. For example, the plurality of sub-frame periods in a frame period may be a plurality of periods which are distant from each other.

In the BL efficiency data storing unit 106, BL efficiency data is recorded in advance. The BL efficiency data is data on the correspondence between the current value of the current that is supplied to the backlight apparatus 200 (light source unit 201), and the light emission efficiency of the backlight apparatus 200.

The pulse determining unit 105 determines a pulse (current pulse) to be supplied to the backlight apparatus 200 for each sub-frame period based on: the target light quantity of the current frame; the BL efficiency data stored in the BL efficiency data storing unit 106; and the determination result by the transmittance determining unit 103. In concrete terms, a pulse to be supplied to the target light source unit 201 in the current sub-frame period is determined for each light source unit 201 based on: the target light quantity; the BL efficiency data, and the determination result by the transmittance determining unit 103 for the divided area 501 corresponding to the target light source unit 201. In this embodiment, pulses are determined so that a target quantity of light is emitted from the liquid crystal panel 500 in the frame period.

The pulse determining unit 105 includes a pulse width determining unit 105-1, a pulse amplitude determining unit 105-2, and a pulse position determining unit 105-3. The pulse width determining unit 105-1 determines a pulse width which is a width of the pulse, the pulse amplitude determining unit 105-2 determines a pulse amplitude which is an amplitude of the pulse, and the pulse position determining unit 105-3 determines a pulse position which is a relative position of the pulse with respect to the current sub-frame period. In this embodiment, the pulse position determining unit 105-3 determines the start timing of the pulse as the pulse position. The end timing of the pulse, the center timing of the pulse or the like may be determined as the pulse position. The pulse width can be regarded as the ON time of the light source unit 201, or as the supply time of the current supplied to the light source unit 201, and the pulse amplitude can be regarded as the current value of the current supplied to the light source unit 201.

In this embodiment, in the case when the current sub-frame period is the stable period, the pulse width determining unit 105-1 determines a pulse width that is different from a pulse width used in the case when the current sub-frame period is the unstable period. In the same manner, in the case when the current sub-frame period is the stable period, the pulse amplitude determining unit 105-2 determines a pulse amplitude that is different from the pulse amplitude used in the case when the current sub-frame period is the unstable period. Then the pulse position determining unit 105-3 determines the pulse position, so that the pulse is set in a period when the transmittance of the liquid crystal panel 500 in the current sub-frame period is relatively high.

The BL driving unit 107 is a driving circuit that supplies the pulse determined by the pulse determining unit 105 to each light source unit 201 (LED 202). The BL driving unit 107 can be regarded as an LED driver.

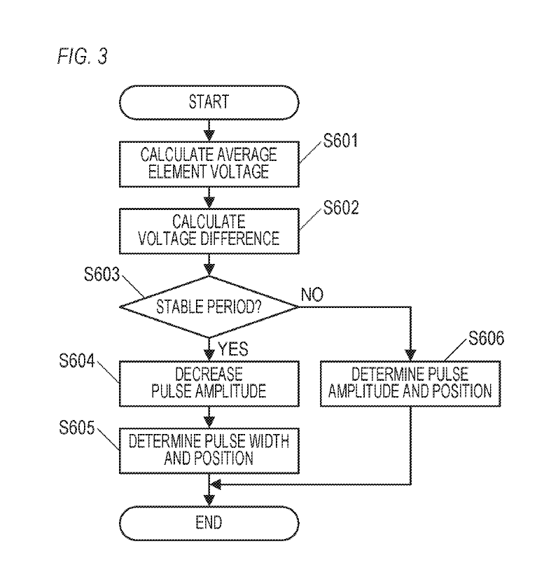

An example of a processing flow of the backlight control apparatus 100 will be described. FIG. 3 is a flow chart depicting an example of a processing flow of the backlight control apparatus 100. This processing flow starts when the user turns ON the power of the liquid crystal display apparatus, and the backlight apparatus 200 starts lighting. In the following processing flow, the second and later frames of the input image data are used as the current frame.

In step S601, for each divided area 501, the panel voltage determining unit 101 calculates an average of a plurality of voltages corresponding to a plurality of liquid crystal elements in the target divided area 501 respectively (average element voltage), based on the input image data of the current frame. It is assumed that the average element voltage of the previous frame has already been calculated.

In step S602, for each divided area 501, the voltage difference calculating unit 102 calculates the voltage difference, that is the difference between the average element voltage of the current frame (voltage calculated in step S601) and the average element voltage of the previous frame.

In step S603, for each divided area 501, the transmittance determining unit 103 determines whether the current sub-frame period is a stable period or not, based on the voltage difference calculated in step S602 and the panel responsiveness data in the panel responsiveness data storing unit 104. Here the current sub-frame period is the subsequent sub-frame period. For example, if the change width of the temporal change in the transmittance of the liquid crystal panel 500 in the current sub-frame period is less than a threshold, the transmittance determining unit 103 determines that the current sub-frame period is a stable period. If the change width of the temporal change in the transmittance of the liquid crystal panel 500 in the current sub-frame period is at least the threshold, on the other hand, then the transmittance determining unit 103 determines that the current sub-frame period is not a stable period but is an unstable period.

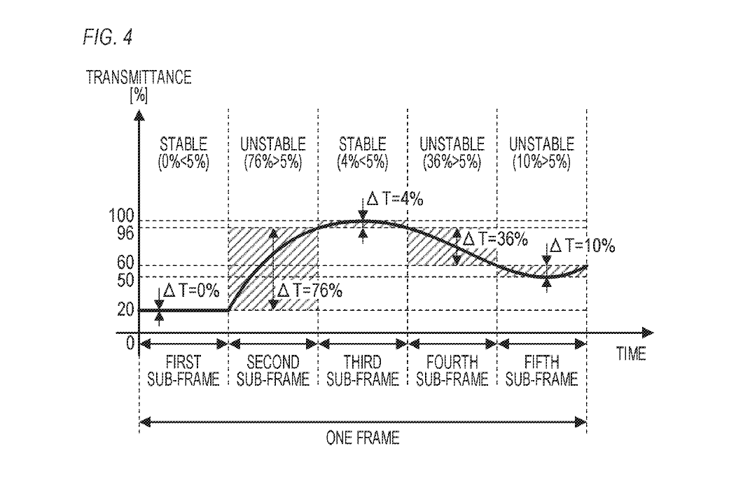

FIG. 4 indicates an example of a temporal change in the transmittance of the liquid crystal panel 500. The abscissa in FIG. 4 indicates time, and the ordinate in FIG. 4 indicates transmittance. In the example in FIG. 4, five sub-frames constituting a frame period are set. The change widths ΔT of the temporal change in the transmittance in the first sub-frame period and the third sub-frame period are less than 5% respectively, hence the first sub-frame period and the third sub-frame period are determined as stable periods. The change widths ΔT in the second sub-frame period, the fourth sub-frame period and the fifth sub-frame period are at least 5% respectively, hence these sub-frame periods are determined as the unstable periods. The threshold may be greater or lesser than 5%.

In steps S604 and S605, or in step S606, the pulse of the current sub-frame period is determined for each light source unit 201 based on: the target light quantity in the current frame; the BL efficiency data in the BL efficiency data storing unit 106; and the determination result in step S603.

In concrete terms, after step S603, the pulse determining unit 105 determines. for each light source unit 201, a pulse width, a pulse amplitude, and a pulse position which are the same among the plurality of sub-frame periods in the current frame period in accordance with the target light quantity. The state where the pulse width, the pulse amplitude and the pulse position are the same among a plurality of sub-frame periods in the current frame period is called the “reference state”. The reference state is a state where the target quantity of light is emitted from the liquid crystal panel 500 in the frame period.

The pulse of the light source unit 201 corresponding to the divided area 501, which was determined that the current sub-frame period is the stable period, is determined in steps S604 and S605. In step S604, the pulse amplitude determining unit 105-2 determines the pulse amplitude by decreasing the pulse amplitude in the reference state based on the BL efficiency data. In step S605, the pulse determining unit 105 (pulse width determining unit 105-1 and pulse position determining unit 105-3) determines the pulse width and the pulse position based on the pulse amplitude determined in step S604 and the target light quantity of the current frame,

The pulse of the light source unit 201 corresponding to the divided area 501, which was determined that the current sub-frame period is the unstable period, is determined in step S606. In step S606, the pulse determining unit 105 (pulse width determining unit 105-1 and pulse position determining unit 105-3) determines the pulse width and the pulse position based on the target light quantity of the current frame. The pulse amplitude determining unit 105-2 uses the pulse amplitude in the reference state. The pulse amplitude in the unstable period may be different from the pulse amplitude in the reference state.

The processing flow in FIG. 3 is a processing flow when the transmittance in the liquid crystal panel 500 gradually increases in the current frame period. Between the stable period and the unstable period in the current frame period, a pulse in the sub-frame period, of which the transmittance of the liquid crystal panel 500 is higher, is determined in steps S604 and S605. Then between the stable period and the unstable period in the current frame period, a pulse in the sub-frame period, of which the transmittance of the liquid crystal panel 500 is lower, is determined in step S606. It is assumed that the transmittance of the liquid crystal panel 500 gradually decreases in the current frame period. In this case, the pulse in the unstable period is determined in steps S604 and S605, and the pulse in the stable period is determined in step S606.

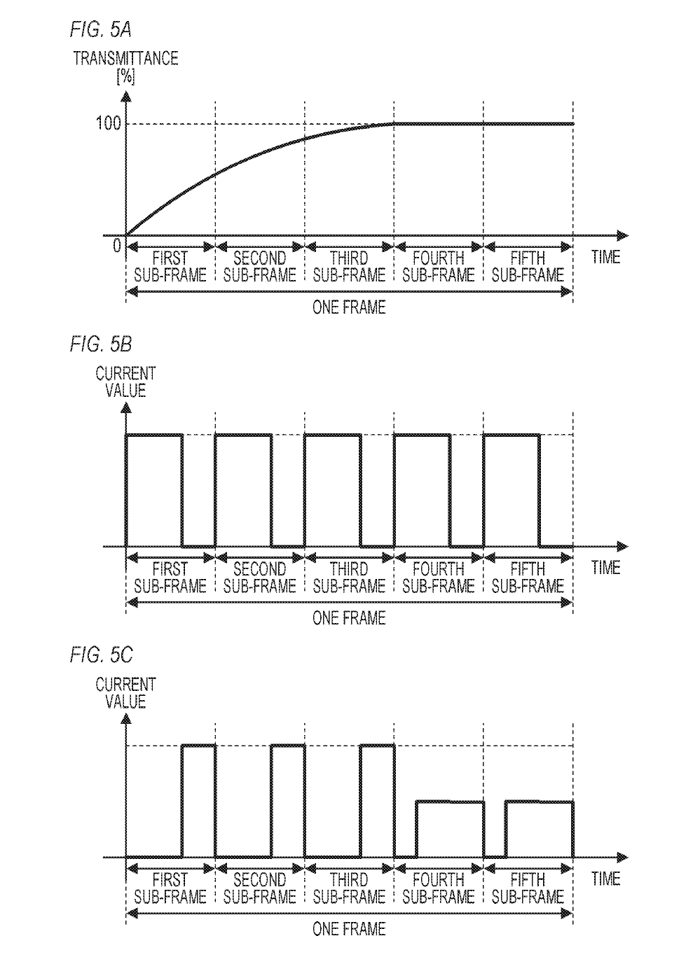

A concrete example of the pulse determining method will be described. FIGS. 5A to 5C depict a concrete example of the pulse determining method. Specifically, FIG. 5A indicates the temporal change in the transmittance of the liquid crystal panel 500 in the frame period, FIG. 5B indicates pulses in the reference state, and. FIG. 5C indicates the determined pulses. The abscissa in FIGS. 5A to 5C indicates time, the ordinate in FIG. 5A indicates transmittance, and the ordinate in FIGS. 5B and 5C indicates a current value.

As indicated in FIG. 5B, in the reference state, the pulse width, the pulse amplitude and the pulse position are the same among a plurality of sub-frame periods in a frame period. In the prior arts, the backlight apparatus 200 is normally driven with the pulses in the reference state. In FIG. 5B, the start timing of the sub-frame period is determined as the pulse position (start timing of the pulse).

In Example 1, the pulse amplitude is determined so as to satisfy at least one of the following Conditions 1 and 2. The pulse width is not especially limited.
Condition 1: Between the stable period and the unstable period, the pulse amplitude in a sub-frame period of which the transmittance of the liquid crystal panel 500 is higher, is lower than the pulse amplitude in the other sub-frame period.
Condition 2: Between the stable period and the unstable period, the pulse amplitude in a sub-frame period, of which the transmittance of the liquid crystal panel 500 is higher, is lower than the pulse amplitude in the reference state.

In FIG. 5A, in a frame period, the transmittance of the liquid crystal panel 500 gradually increases from 0% to 100%. The first sub-frame period, the second sub-frame period and the third sub-frame period are the unstable periods respectively, and the fourth sub-frame period and the fifth sub-frame period are the stable periods respectively. Here the transmittance in the stable period is higher than the transmittance in the unstable period.

In FIG. 5C, the pulse amplitude in the stable period is lower than the pulse amplitude in the unstable period, which means that Condition 1 is satisfied. Further, in FIG. 5C, the pulse amplitude in the stable period is lower than the pulse amplitude in FIG. 5B, which means that Condition 2 is also satisfied. In FIG. 5C, the pulse width in the stable period is wider than the pulse width in the unstable period, the pulse width in the stable period is wider than the pulse in FIG. 5B, and the pulse width in the unstable period is narrower than the pulse width in FIG. 5B.

Then, as mentioned above, the pulse position determining unit 105-3 determines the pulse position, so that a pulse is set in a period of the sub-frame period where the transmittance of the liquid crystal panel 500 is relatively high. In FIG. 5A, the transmittance of the liquid crystal panel 500 gradually increases in the sub-frame period. Therefore in FIG. 5C, the pulse position is determined so that the end timing of the pulse approximately matches with the end timing of the sub-frame period,

The pulse is also determined in the same manner when another temporal change is generated in the transmittance of the liquid crystal panel 500. For example, it is assumed that the transmittance of the liquid crystal panel 500 gradually decreases in a frame period. In this case, for the unstable period, a pulse amplitude that is lower than the pulse amplitude in the stable period and the pulse amplitude in the reference state is determined. Then the pulse position is determined so that the start timing of the pulse approximately matches with the start timing of the sub-frame period.

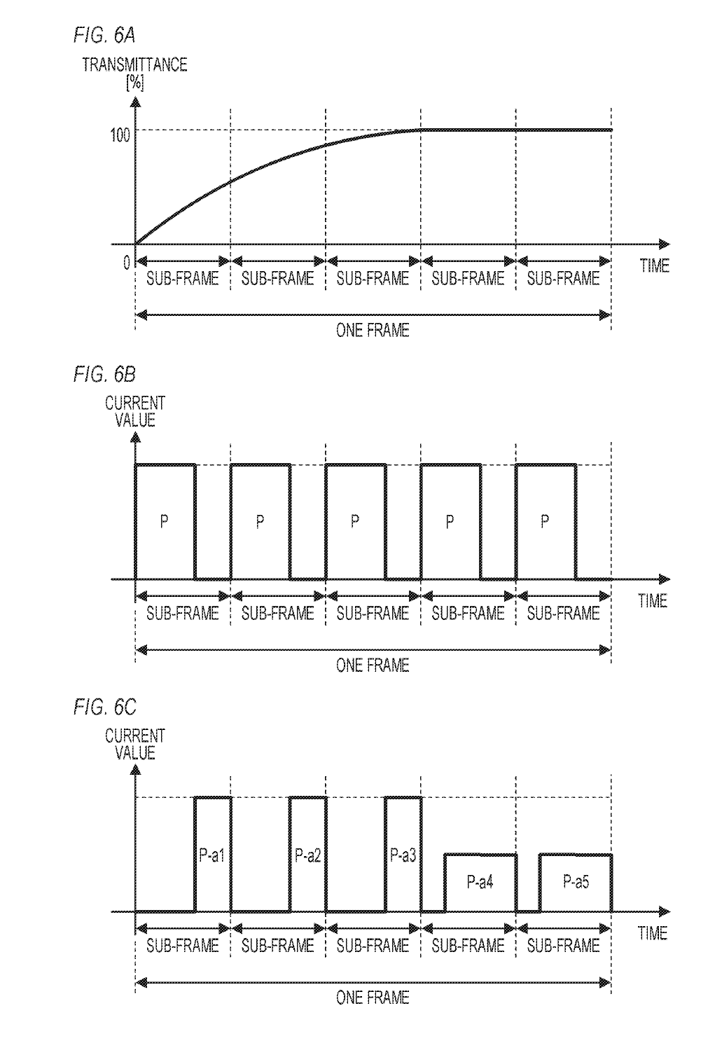

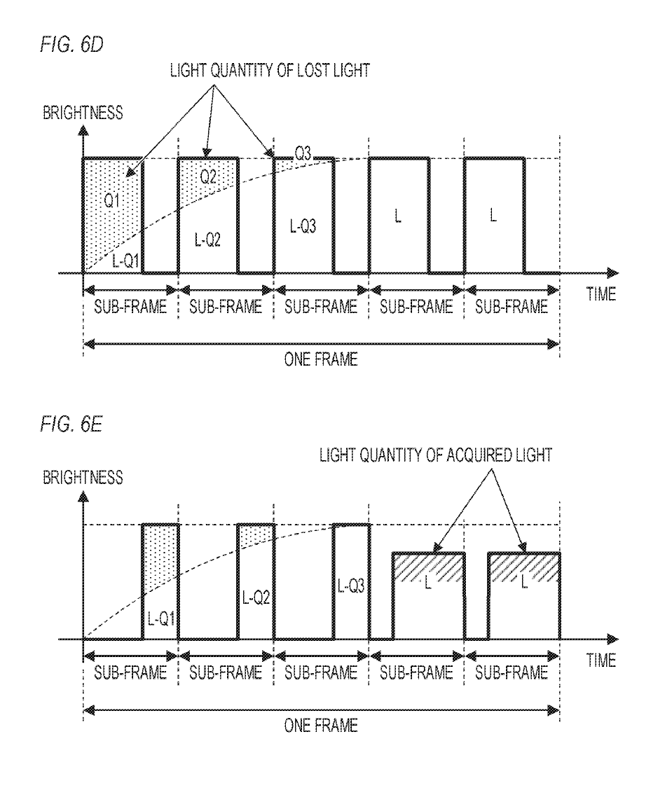

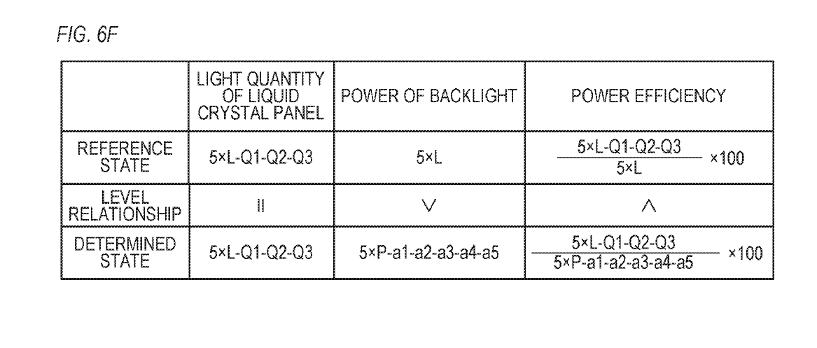

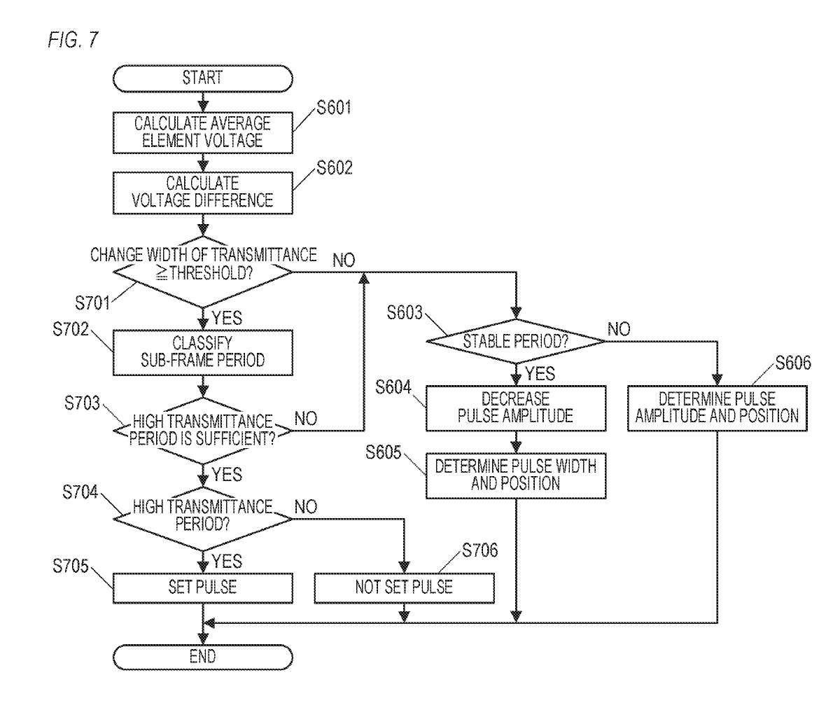

A concrete example of the effect implemented in Example 1 will be described. FIGS. 6A to 6F indicate a concrete example of the effect of Example 1. FIG. 6A indicates a temporal change in the transmittance of the liquid crystal panel 500 in a frame period, which is the same as FIG. 5A, FIG. 6B indicates pulses in the reference state, and is the same as FIG. 5B, and FIG. 6C indicates the determined pulses, and is the same as FIG. 5C. In FIGS. 6B and 6C, the size of the pulse (current value×time) corresponds to the power consumption of the light source unit 201 in the sub-frame period.

FIG. 6D indicates a quantity of light irradiated to the liquid crystal panel 500 when the pulses in the reference state are used. FIG. 6E indicates a quantity of light irradiated to the liquid crystal panel 500 when the determined pulses are used. The abscissa in FIGS. 6D and 6E indicates time, and the ordinate in FIGS. 6D and 6E indicates the brightness of light (instantaneous value). In FIGS. 6D and 6E, the size of an area indicated by dots corresponds to the quantity of light that is not transmitted through the liquid crystal panel 500 (lost light; wasted light). Generally the light emission efficiency of the light source unit 201 is higher as the current value of the current that is supplied to the light source unit 201 is smaller. In FIGS. 6D and 6E, the size of the area indicated by hatched lines corresponds to an increase amount of the emitted light quantity of the light source unit 201 caused by the increase in the light emission efficiency of the light source unit 201 (increase from the reference state). In other words, the size of the area indicated by the hatched lines corresponds to the quantity of light acquired by the increase in the emission efficiency of the light source unit 201 (acquired light).

In the case of using the pulses in the reference state, the power consumption of the light source unit 201 in each sub-frame period becomes power P, as indicated in FIG. 6B. Therefore, as indicated in the following Expression 1-1, the power consumption Va_BL of the light source unit 201 in the frame period becomes power (5×P).

Va_BL=5×P (Expression 1-1)

Further, in the case of using the pulses in the reference state, as indicated in FIG. 6D, the light quantity irradiated to the liquid crystal panel 500 in each sub-frame period becomes light quantity L. Therefore, as indicated in the following Expression 1-2, the light quantity La_BL of the light irradiated to the liquid crystal panel 500 in the frame period becomes light quantity (5×L).

La_BL=5×L (Expression 1-2)

In the case of using the pulses in the reference state, as indicated in FIG. 6D, the light quantity Q1 of lost light is generated in the first sub-frame period, the light quantity Q2 of lost light is generated in the second sub-frame period, and the light quantity Q3 of lost light is generated in the third sub-frame period. Therefore, as indicated in the following Expression 1-3, the light quantity La of the light emitted from the liquid crystal panel 500 in the frame period becomes light quantity (5×L−Q1−Q2−Q3), which is assumed to be the target light quantity.

La=5×L−Q1−Q2−Q3 (Expression 1-3)

This means that if the pulses in the reference state are used, the power efficiency Va becomes efficiency (((5×L−Q1−Q2−Q3)/(5×P))×100), as indicated in the following Expression 1-4.

Va=((5×L−Q1−Q2−Q3)/(5×P))×100 (Expression 1-4)

In the case of using the determined pulses, as indicated in FIG. 6C, the power consumption of the light source unit 201 in the first sub-frame period becomes power (P−a1), the power consumption of the light source unit 201 in the second sub-frame period becomes power (P−a2), the power consumption of the light source unit 201 in the third sub-frame period becomes power (P−a3), the power consumption of the light source unit 201 in the fourth sub-frame period becomes power (P−a4), and the power consumption of the light source unit 201 in the fifth sub-frame period becomes power (P−a5). Therefore, as indicated in the following Expression 2-1, the power consumption Vb_BL of the light source unit 201 in the frame period becomes power (5×P−a1−a2−a3−a4−a5), which is smaller than the power consumption Va_BL in the reference state.

Vb_BL=5×P−a1−a2−a3−a4−a5<Va_BL (Expression 2-1)

Further, in the case of using the determined pulses, as indicated in FIG. 6E, the lost light decreases in the first sub-frame period, the second sub-frame period and the third sub-frame period respectively. In concrete terms, the lost light decreases because a pulse is set in a time of the sub-frame period where the transmittance of the liquid crystal panel 500 is relatively high. Further, in each of the fourth sub-frame period and the fifth sub-frame period, the light emission efficiency of the light source unit 201 increases more than the light emission efficiency in the reference state. In concrete terms, the light emission efficiency increases because the pulse amplitude (current value) is decreased less than the pulse amplitude in the reference state. As a result, as indicated in the following Expression 2-2. the light quantity Lb of the light emitted from the liquid crystal panel 500 in a frame period becomes the light quantity (5×L−Q1−Q2−Q3), which is the same as the light quantity La (target light quantity) in the reference state.

Lb=5×L−Q1−Q2−Q3=La (Expression 2-2)

This means that if the determined pulses are used, the power efficiency Vb becomes the efficiency (((5×L−Q1−Q2−Q3)/(5×P−a1−a2−a3−a4−a5))×100), which is higher than the power efficiency Va in the reference state, as indicated in the following Expression 2-3.

Vb=((5×L−Q1−Q2−Q3)/(5×P−a1−a2−a3−a4−a5))×100>Va (Expression 2-3)

FIG. 6F indicates the result of the above calculation. As indicated in FIG. 6F, the power consumption of the liquid crystal display apparatus (more specifically, the light source unit 201) is decreased less than the power consumption in the reference state, and the power efficiency of the liquid crystal display apparatus (more specifically, the light source unit 201) is improved more than the power efficiency in the reference state, while maintaining the target light quantity.

As described above, according to Example 1, a pulse is set in a period in which transmittance of the liquid crystal panel 500 in the sub-frame period is relatively high. Then in the stable period, a pulse width and a pulse amplitude, that are different from the pulse width and the pulse amplitude in the unstable period, are determined. As a result, the power consumption of the apparatus can be reduced at high precision, while implementing a desired display brightness.

### EXAMPLE 2

Example 2 of the present invention will be described. In Example 2, a case of further improving the power efficiency of the liquid crystal display apparatus by including a control of not turning ON the light source unit 201 in a sub-frame period will be described. In the following, the aspects (configuration and processing) that are different from Example 1 will be described in detail, and description on the aspects that are the same as Example 1 will be omitted.

An example of a processing flow of the backlight control apparatus 100 will be described. FIG. 7 is a flow chart depicting an example of a processing flow of the backlight control apparatus 100. Similarly to the processing flow in FIG. 3, the processing flow in FIG. 7 is also a processing flow when the transmittance of the liquid crystal panel 500 gradually increases in the current frame period.

The processing in steps S601 and S602 are perforated in the same manner as Example 1. Then the processing in step S701 is performed. In step S701, the transmittance determining unit 103 determines, for each divided area 501, whether the change widths of the temporal change in the transmittance of the liquid crystal panel 500 is at least the threshold of the change amount in the current frame. The determination in step S701 can be performed based on the voltage difference calculated in step S602 and the panel responsiveness data in the panel responsiveness data storing unit 104. The threshold is not especially limited, but is 10% in Example 2. For a divided area 501, for which it was determined that the charge width of the temporal change is at least the threshold (10%), processing advances to step S702. For a divided area 501, for which it was determined that the change width of the temporal change is less than the threshold (10%), a pulse is set in the processing in steps S603 to S606, similarly to Example 1.

In step S702, for the processing target divided area 501, the transmittance determining unit 103 classifies each of the plurality of sub-frame periods in the current frame period into a high transmittance period TH and a low transmittance period TL. The high transmittance period TH is a sub-frame period in which transmittance of the liquid crystal panel 500 is relatively high among a plurality of sub-frame periods, and the low transmittance period TL is a sub-frame period in which transmittance of the liquid crystal panel 500 is relatively low among a plurality of sub-frame periods. The classification in step S702 can be performed based on the voltage difference calculated in step S602, and the panel responsiveness data in the panel responsiveness data storing unit 104.

In step S703, for the processing target divided area 501, the transmittance determining unit 103 determines whether the target quantity of light from the liquid crystal panel 500 (target light quantity of current frame) can be acquired in the high transmittance period TH alone. The determination in step S703 can be performed based on the voltage difference calculated in step S602, the panel responsiveness data in the panel responsiveness data storing unit 104, and the target light quantity of the current frame. For a divided area 501 where it is determined that the target quantity of light can be acquired in the high transmittance period TH alone, processing advances to step S704. For a divided area 501 where it is determined that the target quantity of light cannot be acquired in the high transmittance period TH alone, the pulse is set by the processing in steps S603 and S606, similarly to Example 1.

In step S704, for the processing target divided area 501, the transmittance determining unit 103 determines whether the current sub-frame period is the high transmittance period TH. The determination in step S704 can be performed based on the voltage difference calculated in step S602, and the panel responsiveness data in the panel responsiveness data storing unit 104. For a divided area 501, where it is determined that the current sub-frame period is the high transmittance period TH, processing advances to step S705. For a divided area 501, where it is determined that the current sub-frame period is not the high transmittance period TH but the low transmittance period TL, processing advances to S706.

In step S705, for the processing target divided area 501 (light source unit 201 corresponding to the processing target divided area 501), the pulse determining unit 105 sets a pulse in the current sub-frame period which is the high transmittance period TH. The pulse is set based on the target light quantity of the current frame, the BL efficiency data stored in the BL efficiency data storing unit 106, and the classification result in step S702. In step S706, on the other hand, the pulse determining unit 105 does not set a pulse in the current sub-frame period, which is the low transmittance period TL. Since the pulse in the low transmittance period TL is not set, a pulse, of which at least one of the pulse width and the pulse amplitude is larger than the value in the reference state, is set as the pulse in the high transmittance period TH.

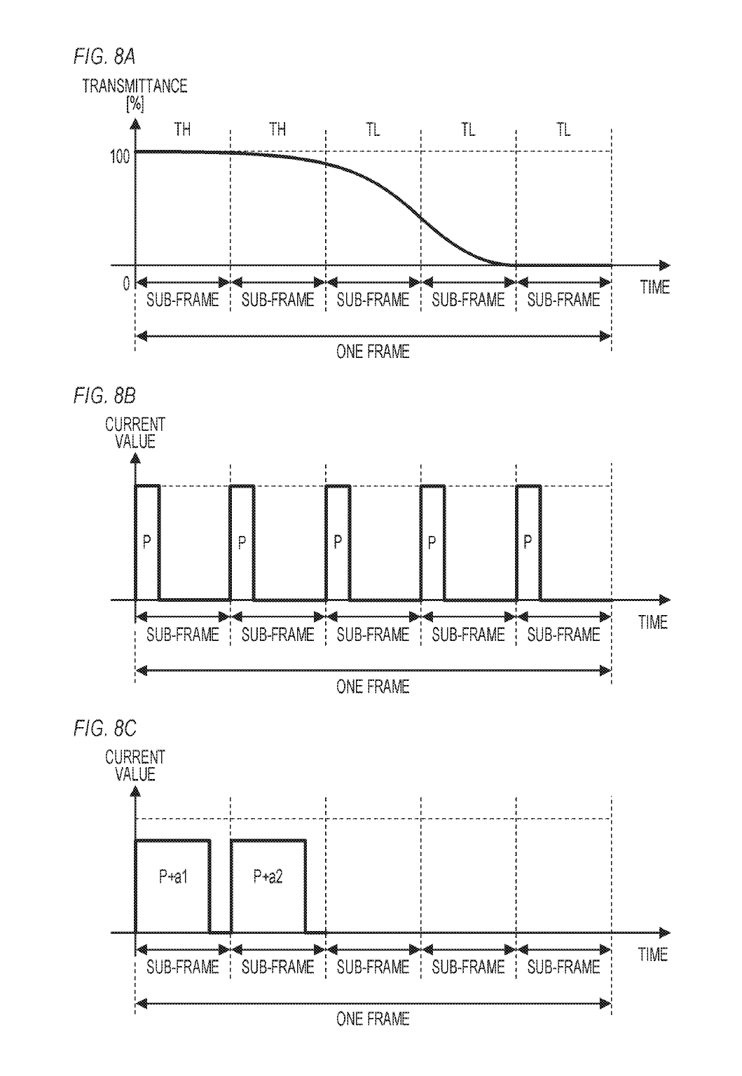

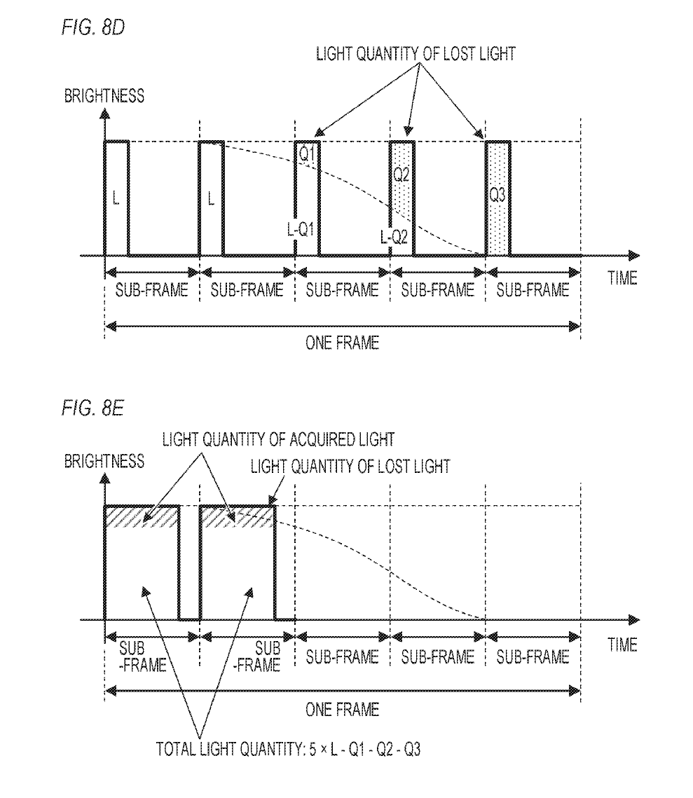

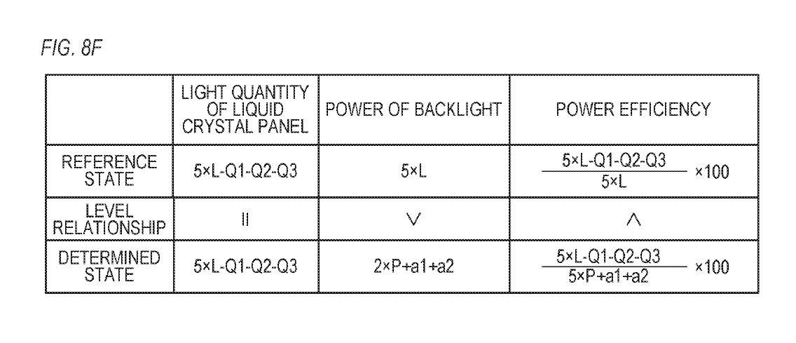

A concrete example of the effect implemented in Example 2 will be described. FIGS. 8A to 8F indicate a concrete example of the effect of Example 2. FIG. 8A indicates a temporal change in the transmittance of the liquid crystal panel 500 in a frame period. FIG. 8B indicates pulses in the reference state, and FIG. 8C indicate the determined pulses. FIG. 8D indicates a quantity of light irradiated to the liquid crystal panel 500 when the pulses in the reference state are used, and FIG. 8E indicate a quantity of light irradiated to the liquid crystal panel 500 when the determined pulses are used.

In FIG. 8A, in a frame period, the transmittance of the liquid crystal panel 500 gradually decreases from 100% to 0%. Therefore the change width of the transmittance of the liquid crystal panel 500 in a frame period is 100%, which is the threshold 10% or more. Further, the transmittance of the liquid crystal panel 500 is high in the first sub-frame period and the second sub-frame period. On the other hand, the transmittance of the liquid crystal panel 500 is low in the third sub-frame period, the fourth sub-frame period, and the fifth sub-frame period. Hence the first sub-frame period and the second sub-frame period are classified to the high transmittance period TH respectively, and the third sub-frame period, the fourth sub-frame period and the fifth sub-frame period are classified to the low transmittance period TL respectively.

Here it is assumed that the target quantity of light can be acquired only in the high transmittance period TH. Therefore, as indicated in FIG. 8C, a pulse is set in the first sub-frame frame period and the second sub-frame period respectively. No pulse is set in the third sub-frame period, the fourth sub-frame period, and the fifth sub-frame period respectively.

In the case of using the pulses in the reference state, the power consumption of the light source unit 201 in each sub-frame period becomes power P, as indicated in FIG. 8B. Therefore, as indicated in the following Expression 3-1, the power consumption Va_BL of the light source unit 201 in the frame period becomes power (5×P).

Va_BL=5×P (Expression 3-1)

Further, in the case of using the pulses in the reference state, as indicated in FIG. 8D, the light quantity of light irradiated to the liquid crystal panel 500 in each sub-frame period becomes light quantity L. Therefore, as indicated in the following Expression 3-2, the light quantity La_BL of the light irradiated to the liquid crystal panel 500 in the frame period becomes light quantity (5×L).

La_BL=5×L (Expression 3-2)

In the case of using the pulses in the reference state, as indicated in FIG. 8D, the light quantity Q1 of lost light is generated in the third sub-frame period, the quantity Q2 of lost light is generated in the fourth sub-frame period, and the light quantity Q3 of lost light is generated in the fifth sub-frame period. Therefore, as indicated in the following Expression 3-3, the light quantity La of the light emitted from the liquid crystal panel 500 in the frame period becomes light quantity (5×L−Q1−Q1−Q3). Here it is assumed that the light quantity (5×L−Q1−Q2−Q3) is the target light quantity.

La=5×L−Q1−Q2−Q3 (Expression 3-3)

This means that if the pulses in the reference state are used, the power efficiency Va becomes efficiency (((5×L−Q1−Q2−Q3)/(5×P))×100), as indicated in the following Expression 3-4.

Va=((5×L−Q1−Q2−Q3)/(5×P))×100 (Expression 3-4)

In the case of using the determined pulses, as indicated in FIG. 8C, the power consumption of the light source unit 201 in the first sub-frame period becomes power (P+a1), and the power consumption of the light source unit 201 in the second sub-frame period becomes power (P+a2). The power consumption of the light source unit 201 is 0 in the third sub-frame period, the fourth sub-frame period and the fifth sub-frame period respectively. Therefore, as indicated in the following Expression 4-1, the power consumption Vb_BL of the light source unit 201 in the frame period becomes power (2×P+a1+a2). Each of the power consumption (P+a1) in the first sub-frame period and the power consumption (P+a2) of the second sub-frame period are larger than the power consumption P in the case of using the pulses in the reference state respectively. However, the power consumption Vb_BL is smaller than the power consumption Va_BL, since the power consumption is in the third to fifth sub-frame periods are zero.

Vb_BL=2×P+a1+a2<Va_BL (Expression 4-1)

Further, in the case of using the determined pulses, as indicated in FIG. 8E, the lost light decreases because the light source unit 201 does not turn ON in the low transmittance period TL (third to fifth sub-frame periods). As a result, as indicated in the following Expression 4-2, the light quantity Lb of the light emitted from the liquid crystal panel 500 in a frame period becomes the light quantity (5×L−Q1−Q2−Q3), which is the same as the light quantity La (target light quantity) in the reference state.

Lb=5×L−Q1−Q2−Q3=La (Expression 4-2)

This means that if the determined pulses are used, the power efficiency Vb becomes (((5×L−Q1−Q2−Q3)/(2×P+a1+a2))×100), which is higher than the power efficiency VA in the reference state.

Vb=((5×L−Q1−Q2−Q3)/(2×P+a1+a2))×100>Va (Expression 4-3)

FIG. 8F indicates the result of the above calculation. As indicated in FIG. 8F, the power consumption of the liquid crystal display apparatus (more specifically, light source unit 201) is decreased less than the power consumption in the reference state, and the power efficiency of the liquid crystal display apparatus (more specifically, the light source unit 201) is improved more than the power efficiency in the reference state, while maintaining the target light quantity.

As described above, according to Example 2, a case when the change width of the temporal change in the transmittance of the liquid crystal panel 500 is at least a threshold, and the target quantity of light from the liquid crystal panel 500 can be acquired only in the high transmittance period TH is detected. In such a case, a pulse is set only for the high transmittance period TR, regardless of whether each sub-frame period is a stable period or unstable period. As a result, the power consumption of the apparatus can be reduced at high precision, while implementing a desired display brightness.

### EXAMPLE 3

Example 3 of the present invention will be described. When a pulse width is large, image quality deterioration, such as blurring of a moving image, may be generated in the displayed image. In Example 3, a case of suppressing image quality deterioration of the displayed image by including a control to limit the pulse width to a threshold or less will be described. In the following, the aspects (configuration and processing) that is different from Example 1 will be described in detail, and description on the aspects that are the same as Example 1 will be omitted.

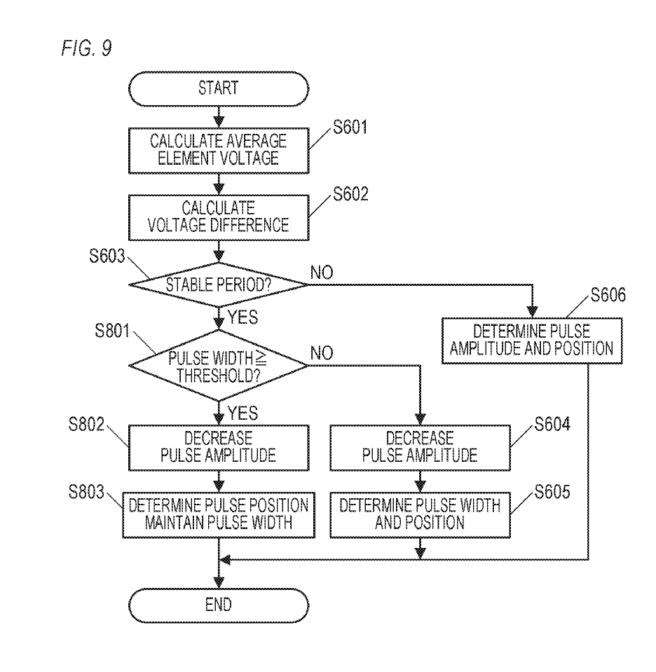

An example of a processing flow of the backlight control apparatus 100 will be described. FIG. 9 is a flow chart depicting an example of a processing flow of the backlight control apparatus 100. Similarly to the processing flow in FIG. 3, the processing flow in FIG. 9 is also a processing flow in the case when the transmittance of the liquid crystal panel 500 gradually increases in the current frame period.

The processing in steps S601 to S603 are performed in the same manner as Example 1. Then the processing advances to step S801 for a divided area 501 for which it is determined that the current sub-frame period is a stable period. In step S801, the pulse determining unit 105 determines, for the light source unit 201 corresponding to the processing target divided area 501, whether the pulse width in the reference state corresponding to the target light quantity in the current frame is at least a threshold. If it is determined that the pulse width in the reference state is at least the threshold, the pulses are set for this light source unit 201 by the processing in steps S802 and S803. If it is determined that the pulse width in the reference state is less than the threshold, the pulse is set for this light source unit 201 by the processing in steps S604 and S605, similarly to Example 1.

In step S802, similarly to step S604, the pulse amplitude determining unit 105-2 determines the pulse amplitude by decreasing the pulse amplitude in the reference state, based on the BL efficiency data. In step S803, the pulse position determining unit 105-3 determines the pulse position so that the end timing of the pulse approximately matches with the end timing of the pulse, and the pulse width determining unit 105-1 uses the pulse width in the reference state. Therefore if the pulse width in the reference state is at least the threshold, the pulse width to be set is limited to the value that is the same as this pulse width.

As described above, according to Example 3, if the pulse width in the reference state is at least the threshold, the pulse width to be set is limited to the value that is the same as this pulse width. Thereby the image quality deterioration of the displayed image can be suppressed.

Each functional unit of Examples 1 to 3 may or may not be independent hardware. The functions of at least two functional units may be implemented by common hardware. Each of a plurality of functions of one functional unit may be implemented by independent hardware. And at least two functions of one functional unit may be implemented by common hardware. Each functional unit may or may not be implemented by hardware. For example, an apparatus may have a processor and a memory storing control programs. Then at least a part of the functions of the functional units of this apparatus may be implemented by the processor reading and executing the control program stored in the memory.

Examples 1 to 3 are merely examples, and configurations implemented by appropriately modifying or changing the configurations of Example 1 to 3, within the scope of the essence of the present invention, are also included in the present invention. Further, the configurations implemented by appropriately combining the configuration of Examples 1 to 3 are also included in the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-239626, filed on Dec. 14, 2017, which is hereby incorporated by reference herein in its entirety.

What is claimed is:

1. A light emission control apparatus configured to control light emission of a light-emitting unit of a display apparatus which includes the light-emitting unit and a display unit configured to display an image on a display surface by transmitting light emitted from the light-emitting unit based on image data, the light emission control apparatus comprising at least one processor that operates as:
a transmittance determining unit configured to determine, based on the image data, a temporal change in transmittance of the display unit in a frame period in which one frame of the image data is displayed; and
a pulse determining unit configured to determine, based on a determination result by the transmittance determining unit, for each of a plurality of partial periods in the frame period, a pulse width which is a width of a pulse supplied to the light-emitting unit, a pulse amplitude which is an amplitude of the pulse, and a pulse position which is a relative position of the pulse with respect to the partial period, so that a target quantity of light is emitted from the display unit in the frame period, wherein
the pulse determining unit
determines a pulse position for each partial period so that the pulse is set in a period where the transmittance of the display unit in the partial period is relatively high, and
determines, for a stable period that is a partial period in which the transmittance of the display unit is approximately constant, a pulse width and a pulse amplitude that are different from a pulse width and a pulse amplitude of an unstable period that is a partial period in which the transmittance of the display unit is approximately not constant.

2. The light emission control apparatus according to claim 1, wherein
for one partial period of the stable period and the unstable period, the pulse determining unit determines a pulse amplitude that is smaller than the pulse amplitude of the other partial period of the stable period and the unstable period, the transmittance of the display unit in the one partial period being higher than that in the other partial period.

3. The light emission control apparatus according to claim 1, wherein
in a case where the transmittance of the display unit gradually increases in the frame period, the pulse determining unit determines, for the stable period, a pulse amplitude that is smaller than the pulse amplitude of the unstable period.

4. The light emission control apparatus according to claim 1, wherein
in a case where the transmittance of the display unit gradually decreases in the frame period, the pulse determining unit determines, for the unstable period, a pulse amplitude that is smaller than the pulse amplitude of the stable period.

5. The light emission control apparatus according to claim 1, wherein
for one partial period of the stable period and the unstable period, the pulse determining unit determines a pulse amplitude that is smaller than the pulse amplitude in a reference state, where the target quantity of light is emitted from the display unit in the frame period, and the pulse width, the pulse amplitude and the pulse position are the same among the plurality of partial periods, the transmittance of the display unit in the one partial period being higher than that in the other partial period.

6. The light emission control apparatus according to claim 5, wherein
in a case where the transmittance of the display unit gradually increases in the frame period, the pulse determining unit determines, for the stable period, a pulse amplitude that is smaller than the pulse amplitude in the reference state.

7. The light emission control apparatus according to claim 5, wherein
in a case where the transmittance of the display unit gradually decreases in the frame period, the pulse determining unit determines, for the unstable period, a pulse amplitude that is smaller than the pulse amplitude in the reference state.

8. The light emission control apparatus according to claim 1, wherein
in a case where the transmittance of the display unit gradually increases in the frame period, the pulse determining unit determines a pulse position for each partial period, so that an end timing of the pulse approximately matches with an end timing of the partial period.

9. The light emission control apparatus according to claim 1, wherein
in a case where the transmittance of the display unit gradually decreases in the frame period, the pulse determining unit determines a pulse position for each partial period, so that a start timing of the pulse approximately matches with a start timing of the partial period.

10. The light emission control apparatus according to claim 1, wherein
the stable period is a partial period in which a change width of the temporal change in the transmittance of the display unit is less than a first threshold, and
the unstable period is a partial period in which the change width of the temporal change in the transmittance of the display unit is at least the first threshold.

11. The light emission control apparatus according to claim 1, wherein
in a case where the temporal change in the transmittance of the display unit has a change width that is at least a second threshold in the frame period, and the target quantity of light from the display unit can be acquired only in a partial period in which the transmittance of the display unit is relatively high among the plurality of partial periods, the pulse determining unit sets a pulse only for the partial period in which the transmittance of the display unit is relatively high, regardless of whether each partial period is the stable period or unstable period.

12. The light emission control apparatus according to claim 1, wherein
in a reference state where the target quantity of light is emitted from the display unit in the frame period, and the pulse width, the pulse amplitude and the pulse position are the same among the plurality of partial periods, the pulse width is a pulse width based on the image data, and
in a case where the pulse width in the reference state is at least a third threshold, the determining unit uses the pulse width in the reference state, for one partial period of the stable period and unstable period, the transmittance of the display unit in the one partial period being higher than that in the other partial period.

13. The light emission control apparatus according to claim 1, wherein
the light-emitting unit includes a plurality of light source units which correspond respectively to a plurality of areas of the display surface,
the transmittance determining unit determines the temporal change in the transmittance of the display unit in the frame period, for each of the plurality of areas of the display surface, and
the pulse determining unit determines the pulse width, the pulse amplitude and the pulse position for each of the plurality of light source units.

14. A light emission control method for controlling light emission of a light-emitting unit of a display apparatus which includes the light-emitting unit and a display unit configured to display an image on a display surface by transmitting light emitted from the light-emitting unit based on image data, the light emission control method comprising:
a transmittance determining step of determining, based on the image data, a temporal change in transmittance of the display unit in a frame period in which one frame of the image data is displayed; and
a pulse determining step of determining, based on a determination result in the transmittance determining step, for each of a plurality of partial periods in the frame period, a pulse width which is a width of a pulse supplied to the light-emitting unit, a pulse amplitude which is an amplitude of the pulse, and a pulse position which is a relative position of the pulse with respect to the partial period, so that a target quantity of light is emitted from the display unit in the frame period, wherein
in the pulse determining step,
a pulse position is determined for each partial period so that the pulse is set in a period where the transmittance of the display unit in the partial period is relatively high, and
for a stable period that is a partial period in which the transmittance of the display unit is approximately constant, a pulse width and a pulse amplitude that are different from a pulse width and a pulse amplitude of an unstable period are determined, the unstable period being a partial period in which the transmittance of the display unit is approximately not constant.

15. A non-transitory computer readable medium that stores a program, wherein
the program causes a computer to execute a light emission control method for controlling light emission of a light-emitting unit of a display apparatus which includes the light-emitting unit and a display unit configured to display an image on a display surface by transmitting light emitted from the light-emitting unit based on image data,
the light emission control method includes:
a transmittance determining step of determining, based on the image data, a temporal change in transmittance of the display unit in a frame period in which one frame of the image data is displayed; and
a pulse determining step of determining, based on a determination result in the transmittance determining step, for each of a plurality of partial periods in the frame period, a pulse width which is a width of a pulse supplied to the light-emitting unit, a pulse amplitude which is an amplitude of the pulse, and a pulse position which is a relative position of the pulse with respect to the partial period, so that a target quantity of light is emitted from the display unit in the frame period, and
in the pulse determining step,
a pulse position is determined for each partial period so that the pulse is set in a period where the transmittance of the display unit in the partial period is relatively high, and
for a stable period that is a partial period in which the transmittance of the display unit is approximately constant, a pulse width and a pulse amplitude that are different from a pulse width and a pulse amplitude of an unstable period are determined, the unstable period being a partial period in which the transmittance of the display unit is approximately not constant.
